(19) United States
(12) Patent Application Publication
(10) Pub. No.: US 2009/0067911 A1
(43) Pub. Date: Mar. 12, 2009

(54) Printing method, printing device, and method of producing printing material

(75) Inventor: Kunihiko Matsuhashi, Shiojiti-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/283,150

(22) Filed: Sep. 10, 2008

(30) Foreign Application Priority Data
Sep. 12, 2007 (JP) 2007-237097
Jun. 13, 2008 (JP) 2008-155703

(51) Int. Cl. B41J 11/00; B41J 15/00

(52) U.S. Cl. 400/582; 400/619

(57) ABSTRACT

There is provided a printing method using a printing device having a transport mechanism that transports a continuous medium in a transport direction, a head that prints an image on the continuous medium, and a sensor. The printing method includes transporting the continuous medium with one side face of two side faces of the continuous medium guided and printing a mark on the other side face of the continuous medium at a time when an image is printed on a front surface of the continuous medium, and transporting the continuous medium with the other side face of the continuous medium guided and printing an image based on a detection position acquired from detecting the mark by using the sensor at a time when an image is printed on a rear surface of the continuous medium.

### BACKGROUND

1. Technical Field

The present invention relates to a printing method, a printing device, and a method of producing a printing material.

2. Related Art

Double-sided printing devices that print on front and rear surfaces of a single sheet such as an A4-size sheet have been known. In the double-sided printing devices for single sheets, a front or rear surface printing process is started by detecting the front end of a single sheet using a sheet detecting sensor. As described above, when a head poking operation is performed for each single sheet with reference to the front end of the single sheet, a positional deviation between front and rear surface images may be easily generated (see JP-A-2001-287427).

However, in a case where double-sided printing is performed for a long continuous sheet, by only performing a head poking operation at the start of a printing process, the positional deviation between front and rear surface images may be generated due to a transport error of the printing device as the printing process advances.

### SUMMARY

An advantage of some aspects of the invention is that it provides a printing method, a printing device, and a method of producing a printing material capable of decreasing the positional deviation between front and rear surface images.

According to a primary aspect of the invention, there is provided a printing method using a printing device having a transport mechanism that transports a continuous medium in a transport direction, a head that prints an image on the continuous medium, and a sensor. The printing method includes: transporting the continuous medium with one side face of two side faces of the continuous medium guided and printing a mark on the other side face of the continuous medium at a time when an image is printed on a front surface of the continuous medium; and transporting the continuous medium with the other side face of the continuous medium guided and printing an image based on a detection position acquired from detecting the mark by using the sensor at a time when an image is printed on a rear surface of the continuous medium.

Other aspects of the invention will be apparent by describing in detail embodiments thereof and the attached drawings.

### BRIEF DESCRIPTION OF THE DRAWINGS

The invention will be described with reference to the accompanying drawings, wherein like numbers reference like elements.

FIG. 1 is a block diagram showing the configuration of a printing system according to an embodiment of the invention.

FIG. 2A is a schematic cross-section view of a printer according to an embodiment of the invention.

FIG. 2B is a schematic top view of the printer.

FIG. 3 shows the arrangement of nozzles on the lower face of a head unit according to an embodiment of the invention.

FIG. 4A shows a pattern in which printing materials “a” are printed on a printing tape according to an embodiment of the invention.

FIG. 4B shows the number of the printing materials “a” that can be printed in a maximum print area according to an embodiment of the invention.

FIG. 4C is a diagram showing printing materials “a” that are printed in a unit area according to an embodiment of the invention.

FIG. 5 is a diagram showing a width guiding part according to an embodiment of the invention.

FIG. 6 is a diagram showing patterns of front surface printing according to an embodiment of the invention.

FIG. 7 shows a pattern of rear surface printing according to an embodiment of the invention.

FIGS. 8A and 8B are diagrams showing a difference in supply of a continuous medium in front and rear surface processes according to an embodiment of the invention.

### DESCRIPTION OF EXEMPLARY EMBODIMENTS

### Overview of Disclosure

At least the following aspects become apparent by describing embodiments thereof and the attached drawings.

According to a first aspect of the invention, there is provided a printing method using a printing device having a transport mechanism that transports a continuous medium in a transport direction, a head that prints an image on the continuous medium, and a sensor. The printing method includes: transporting the continuous medium with one side face of two side faces of the continuous medium guided and printing a mark on the other side face of the continuous medium at a time when an image is printed on a front surface of the continuous medium; and transporting the continuous medium with the other side face of the continuous medium guided and printing an image based on a detection position acquired from detecting the mark by using the sensor at a time when an image is printed on a rear surface of the continuous medium.

According to the above-described printing method, a position relationship between the mark and the sensor in the width direction that intersects the transport direction can be maintained to be fixed. Thus, the position of the image printed on the front surface can be known assuredly, and accordingly, the positional deviation between the front and rear surface images can be prevented.

In the above-described method, it may be configured that the printing device includes a fixed guide and a movable guide, the movable guide can be moved in a width direction that is a direction for intersecting the transport direction, the continuous medium is transported with the one side face of the continuous medium guided by the fixed guide and the other side face of the continuous medium guided by the movable guide at the time when the image is printed on the front surface of the continuous medium, and the continuous medium is transported with the one side face of the continuous medium guided by the movable guide and the other side face of the continuous medium guided by the fixed guide at the time when the image is printed on the rear surface of the continuous medium.

In such a case, the position of the mark in the width direction relative to the printing device is maintained to be fixed all the time, ant the position of the sensor in the width direction can be fixed. Accordingly, a position relationship between the mark and the sensor can be maintained to be fixed. Therefore, a positional deviation between the front and rear surface images can be prevented. In addition, a printing process for continuous media having various widths can be performed by using the movable guide.

In the above-described method, it may be configured that, when the image is printed on the front surface of the continuous medium, a transport mark that is different from the mark is printed on the one side face of the continuous medium and the transport mechanism transports the continuous medium based on a detection position acquired from detecting the transport mark by using a transport sensor that is different from the sensor.

In such a case, a transport error in transporting the continuous medium can be decreased.

In the above-described method, the sensor and the transport sensor may be disposed to be deviated from each other in the transport direction.

In such a case, it can be prevented that two sensors (the sensor and the transport sensor) face each other. Thus, objects that the two sensors face can be configured by objects having non-continuous medium reflectivity. As a result, presence of the medium can be detected assuredly.

According to a second aspect of the invention, there is provided a printing device including: a transport mechanism that transports a continuous medium in a transport direction; a head that prints an image on the continuous medium; and a sensor. The continuous medium is transported with one side face of two side faces of the continuous medium guided and a mark is printed on the other side face of the continuous medium at a time when an image is printed on a front surface of the continuous medium, and the continuous medium is transported with the other side face of the continuous medium guided, and an image is printed based on a detection position acquired from detecting the mark by using the sensor at a time when an image is printed on a rear surface of the continuous medium.

According to the above-described printing device, a positional deviation between the front and rear surface images can be prevented.

According to a third aspect of the invention, there is provided a method of producing a printing material in which images are printed on front and rear surfaces of a continuous medium by using a printing device having a transport mechanism that transports a continuous medium in a transport direction, a head that prints an image on the continuous medium, and a sensor. The method includes: transporting the continuous medium with one side face of two side faces of the continuous medium guided and printing a mark on the other side face of the continuous medium at a time when an image is printed on a front surface of the continuous medium; and transporting the continuous medium with the other side face of the continuous medium guided and printing an image based on a detection position acquired from detecting the mark by using the sensor at a time when an image is printed on a rear surface of the continuous medium.

According to the above-described method of producing a printing material, a positional deviation between the front and rear surface images in the printing material can be prevented.

### Ink Jet Printer

Hereinafter, a printing system in which an ink jet printer printing an image and a print data generating PC (personal computer) generating print data are interconnected will be described as an example of a printing device.

The inkjet printer (hereinafter, referred to as a printer 1 prints a unit image that is to be cut out and used on a continuous medium S (a printing tape, a board, a film, or the like). The unit image is printed continuously in the direction in which the continuous medium is continued. As the unit image, for example, there is a seal-shaped printing material that is attached to a wrapping film of a fresh food. The printing material is not limited to a printing material having an adhesive surface opposite to the printing surface as the seal-shaped printing material. Thus, the printing material may be a printing material (for example, a printing material of a pet bottle) that is attached to a merchandise to be wrapped or a printing material (for example, a tag attached to clothes) that is threaded to be attached. In particular, double-sided printing is performed for a tag (a printing material) attached to clothes, and this ink jet printer can perform a double-sided printing operation.

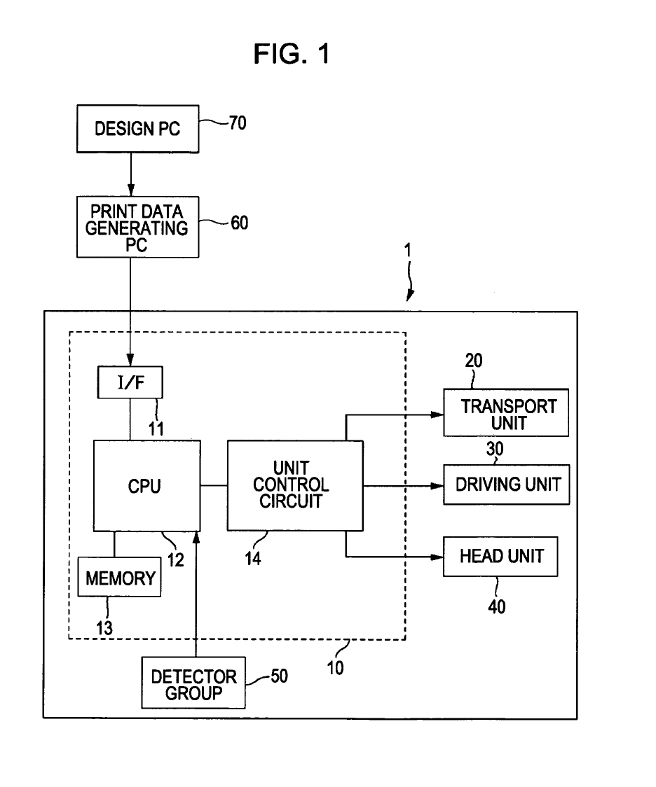

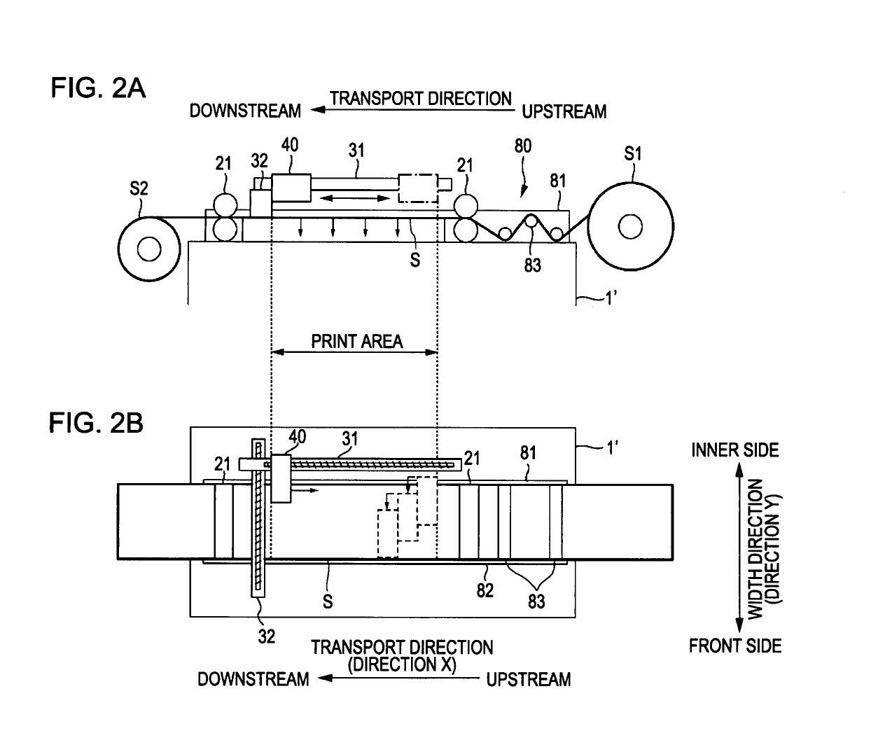

FIG. 1 is a block diagram showing the configuration of a printing system. FIG. 2A is a schematic cross-section view of the printer 1, and FIG. 2B is a schematic top view of the printer 1. First, design of a printing material is generated by a design PC 70, and then image data of the generated printing material is transmitted to a print data generating PC 60. The print data generating PC 60 performs a layout operation that determines the way in which an image of the printing material is printed on a continuous medium S, converts the image data of the laid-out printing material into print data that can be printed by the printer 1, and transmits the print data to the printer 1.

When receiving the print data, the printer 1 controls each unit (a transport unit 20, a driving unit 30, and a head unit 40) by using a controller 10 so as to form an image on the continuous medium S. In addition, the status 1 inside the printer 1 is monitored by a detector group 50, and the controller 10 controls each unit based on the result of detection.

The transport unit 20 transports the continuous medium S from the upstream side to the downstream side in the direction (hereinafter, referred to as a transport direction) in which the continuous medium S is continued. The roll-shaped continuous medium S1 before print is supplied to a print area by a transport roller 21 that is driven by a motor, and then, the continuous medium S2 after print is wound up in a roll shape by a winding mechanism. During a printing process, in the print area, the continuous medium S is vacuumed to be adsorbed from the bottom side, and a printing tape is held in a predetermined position.

The driving unit 30 freely moves the head unit 40 in direction X corresponding to the transport direction of the continuous medium S and in direction Y corresponding to the width direction of the continuous medium S. The driving unit 30 is configured by an X-axis stage 31 that moves the head unit 40 in direction X and a Y-axis stage 32 that moves the X-axis stage 31 in direction Y, and a motor (not shown) that moves the X-axis and Y-axis stages.

The head unit 40 is used for forming an image and has a plurality of heads 41. On the lower face of the head 41, a plurality of nozzles serving as ink ejecting units is disposed. In each nozzle, an ink chamber in which ink is filled is disposed.

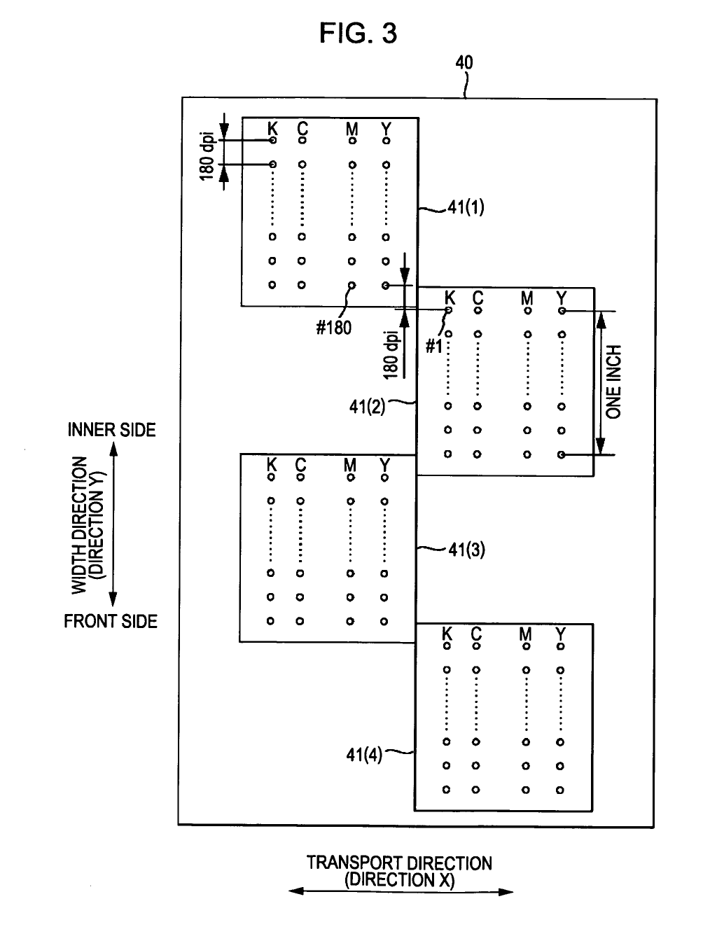

FIG. 3 shows the arrangement of nozzles on the lower face of the head unit 40. The head unit 40 has four heads 41, and the four heads 41 are disposed to be aligned in a zigzag pattern in the width direction. On the lower face of each head 41, a yellow ink nozzle array Y, a magenta ink nozzle array M, a cyan ink nozzle array C, and a black ink nozzle array K are formed. Each nozzle array has 180 nozzles, and the nozzles are arranged with a predetermined gap (180 dpi) interposed therebetween in the width direction. In addition, between two heads (for example, 41(1) and 41(2)) that are adjacent in the width direction, a gap between the foremost nozzle #180 of an inner-side head 41(1) and the innermost nozzle #1 of a front-side head 41(2) is also set to 180 dpi. In other words, on the lower face of the head unit 40, the nozzles are aligned with a predetermined gap (180 dpi) interposed therebetween in the width direction over four inches.

Next, the sequence of a printing process will be described. First, the head unit 40 is moved in direction X (the transport direction) relative to the continuous medium S, which has been supplied to the print area by the transport unit 20, by the X-axis stage 31. During the movement of the head unit, ink is ejected from the nozzles, and dot arrays are formed on the continuous medium S along direction X. Thereafter, the head unit 40 is moved in direction Y (the width direction) through the X-axis stage 31 by the Y-axis stage 32. Thereafter, while the head unit 40 is moved in direction X again, a printing operation is performed. As described above, by repeating a dot forming operation performed in accordance with movement of the head unit 40 in direction X and movement of the head unit 40 in direction Y alternately, a dot is formed in a position different from the position of a dot that has been formed by the previous dot forming operation, and thereby forming an image is completed. As described above, when the printing operation (image forming operation) for the continuous medium S supplied (the transport operation) to the print area is completed, an area of the continuous medium S in which the printing operation is not performed by the transport unit 20 is supplied to the print area (transport direction), and thereby an image is formed. By repeating the image forming operation and the transport operation for the continuous medium S alternately, a plurality of printing materials is printed on the continuous medium S in a state that the plurality of materials is aligned in the transport direction.

### Generation of Print Data

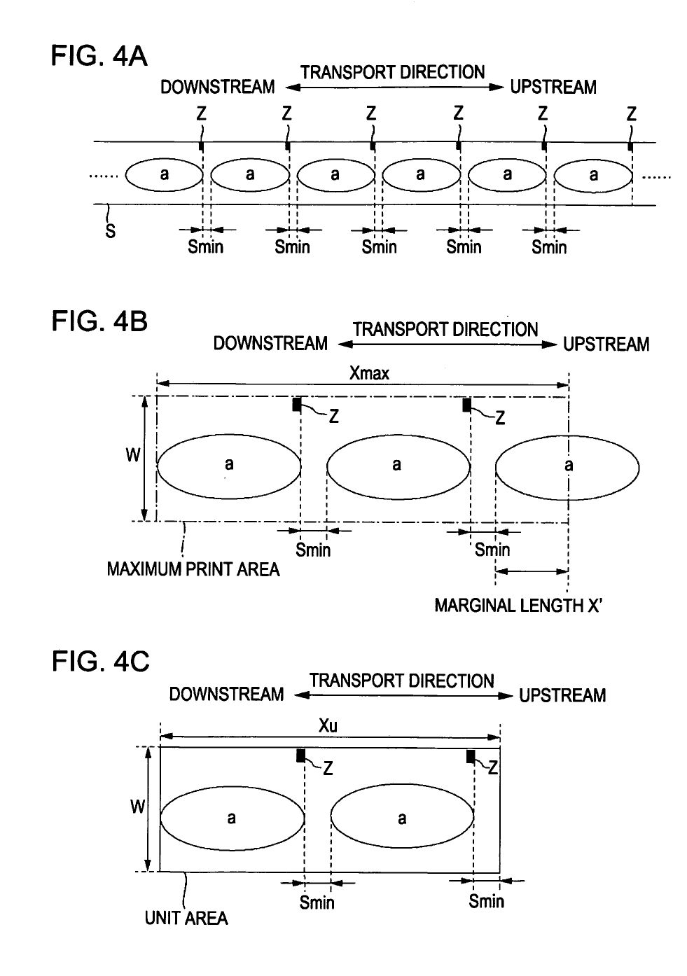

FIG. 4A shows a pattern in which printing materials “a” are printed on the continuous medium S. FIG. 4B shows the number of the printing materials “a” that can be printed in a maximum print area (an area surrounded by a dashed-dotted line). Hereinafter, a method of generating print data used for printing the printing material “a” will be described. The printing materials “a” are to be printed on only one side of the continuous medium S.

First, when receiving data (image data, the number of prints, and the like) for the printing material “a” that has been designed by the design PC 70, the print data generating PC 60 generates print data that is used for printing the printing materials “a” of a designated number by using the printer 1.

In the printer 1 according to this embodiment, the printing process is performed by alternately repeating the transport operation for the continuous medium S and the image forming operation by using the head unit 40. Thus, a print area (hereinafter, referred to as a maximum print area) that is printable by one image forming operation is determined in advance. In other words, a maximum distance Xmax the head unit 40 can be reciprocated in the transport direction becomes the length Xmax of the maximum print area in the transport direction. In addition, the length of the width of the continuous medium S becomes the length of the maximum print area in the width direction.

Accordingly, the printing materials “a” corresponding to an integer should be printed by one image forming operation. The reason is as follows. As shown in FIG. 4B, in a case where two and a half printing materials “a” are printed in a previous image forming operation and the remaining half printing material “a” and two printing materials “a” are printed in the next image forming operation, when an error is generated in the transport operation for the continuous medium S, images are overlapped with each other or a gap between the images is generated to generate a defect in a boundary of the printing materials “a” that are printed by two image forming operations. Thus, printing materials corresponding to an integer are configured to be printed by one image forming operation.

As shown in FIG. 4A, the printing materials “a” are aligned to be printed with a same gap Smin interposed therebetween in the transport direction. Then, the continuous medium after print is provided to a user in a state (complete extraction) that the printing materials “a” are separated one by one by an extraction device or the like as an external device. Accordingly, when the printing materials “a” are printed to be equally spaced in the transport direction of the continuous medium, the extraction device can perform the complete extraction for the printing materials at predetermined time intervals. In addition, in order to prevent the extraction device from separating the printing materials in a wrong position, not only the printing materials “a” but also extraction marks Z that represent the positions of the printing materials “a” are printed on the continuous medium S. By detecting the extraction mark Z using a sensor, it can be checked whether the printing materials are aligned to be equally spaced for being printed. In addition, the extraction mark Z is printed such that the front end of the printing material “a” on the downstream side and the front end of the extraction mark Z on the downstream side coincide with each other in the transport direction.

In consideration of these, the print data generating PC 60 performs a layout operation in which the size of a print area (hereinafter, referred to as a unit area) to be printed by one image forming operation is determined and a method of printing the printing materials “a” in the unit area is determined. This layout operation is performed based on a layout software program stored in the print data generating PC. Hereinafter, the layout operation will be described in detail.

First, the print data generating PC 60 calculates how many printing materials “a” can be printed in the maximum print area printable by one image forming operation. As described above, the printing materials “a” are printed to be equally spaced in the transport direction. However, when the gap of the printing materials “a” in the transport direction is set large, the continuous medium S is consumed unnecessarily. Accordingly, it is preferable that the gap of the printing materials “a” in the transport direction is small as possibly as can be. Here, the gap is set to the minimum gap Smin that is needed for performing complete extraction.

As shown in FIG. 4B, it is assumed that two and a half printing materials “a” are calculated to be able to be printed within the maximum print area, with being aligned to have a minimum gap Smin in the transport direction. In such a case, the number of the printing materials “a” that are printed by one image forming operation is determined as a maximum integer that is not larger than the number (two and a half) of the printing materials printable within the maximum print area, that is, two. In addition, the number of the printing materials printable by one image forming operation may be calculated by actually laying out image data of the printing material “a” in image data corresponding to the maximum print area or calculated based on the size of the maximum print area and the size of the printing material “a”.

FIG. 4C is a diagram showing the printing materials “a” that are printed in the unit area (denoted by a solid line). When the number (two) of the printing materials to be printed by one image forming operation is determined, the size of the unit area is set. As shown in FIG. 4B, when two printing materials “a” are disposed to have a gap of Smin in the transport direction therebetween within the maximum print area and a minimum gap Smin is arranged on the upstream side of the printing material “a” in the transport direction, a marginal length X′ of the maximum print area in the transport direction is formed. A length Xu acquired from subtracting the marginal length X′ from the length Xmax of the maximum print area in the transport direction corresponds to the length of the unit area in the transport direction.

Then, by repeatedly printing an image of the unit area shown in FIG. 4C in the transport direction, a gap between the printing material “a” of the unit area previously printed on the upstream side and the printing material “a” of the unit area printed thereafter on the downstream side becomes the minimum gap Smin, and, as shown in FIG. 4A, the printing materials “a” are aligned to interpose a predetermined gap Smin therebetween in the transport direction and printed on the continuous medium S.

As described above, the layout operation, in which the size of the unit area and a method of printing the printing materials “a” in the unit area are determined, is completed, a printer driver converts image data of an image (FIG. 4C) to be printed in the unit area into print data that can be printed by the printer 1. First, the resolution of the image data of the unit area is converted into a resolution at which the printer 1 can print. Then, a color converting process for representing the image data of the unit area, which is RGB data, in a color space corresponding to colors of ink (YMCK) of the printer 1 is performed. Then, the image data of the unit area having high gray scale levels (for example, 256 gray scale levels) is converted into data having gray scale levels (for example, 4 gray scale levels) that can be formed by the printer 1 (a half-tone process), and data is rearranged in accordance with the print order of the printer 1 (a rasterizing process). Through the above-described processes, the print data of the unit area is transmitted from the printer driver (the print data generating PC 60) to the printer 1 together with a command data (the amount of transport of the continuous medium S and the like) corresponding to a print mode.

In one image forming operation, the print data of the unit area is repeatedly used to be printed for repeatedly printing the image shown in FIG. 4C. The amount of transport of the continuous medium S in one transport operation becomes the length Xu of the unit area in the transport direction. In other words, a moving distance of the head unit 40 in the transport direction for one image forming operation becomes the length Xu of the unit area in the transport direction. As described above, by setting the unit area such that the printing materials are aligned and printed with the minimum gap Smin in the transport direction interposed therebetween, the moving distance Xu of the head 40 in the transport direction becomes shorter than the maximum distance Xmax, for which the head unit 40 can be moved in the transport direction, depending on the size of the printing material. Accordingly, a time for a printing operation is shortened.

### Double-Sided Printing

Hereinafter, a double-sided printing process for a printing material will be described. For a single sheet (cut sheet) such as an A4 size sheet other than the continuous medium S, the position of a front end of each single sheet is detected by a sensor, and the single sheet is positioned at a print start position (a head poking operation). Thus, in a double-sided printing process for a single sheet, a head poking operation is performed with respect to the front end position of each single sheet (image) for front-surface printing and rear-surface printing, and accordingly, a positional deviation of images on the front and rear surfaces rarely occurs. However, for a continuous medium S, by only performing a head-poking operation based on the front end position of the continuous medium S at the start of a printing process, a positional deviation of the front and rear surface images may occur due to a transport error or the like as the printing process progresses.

In addition, each of the plurality of the printing materials (images) that are aligned in the transport direction of the continuous medium S is finally separated from the continuous medium S. Thus, in a case where the positional deviation of the front and rear surface images of the continuous medium S occurs, when the printing materials are separated from the continuous medium S, a part of the image is cut out.

The object of this embodiment is to prevent the positional deviation of the front and rear surface images on the continuous medium S, so that an image that is printed on double sides is not lost.

Before describing double-sided printing, position adjustment of a movable guide rail 82 that is an operation for preparing a printing process will now be described.

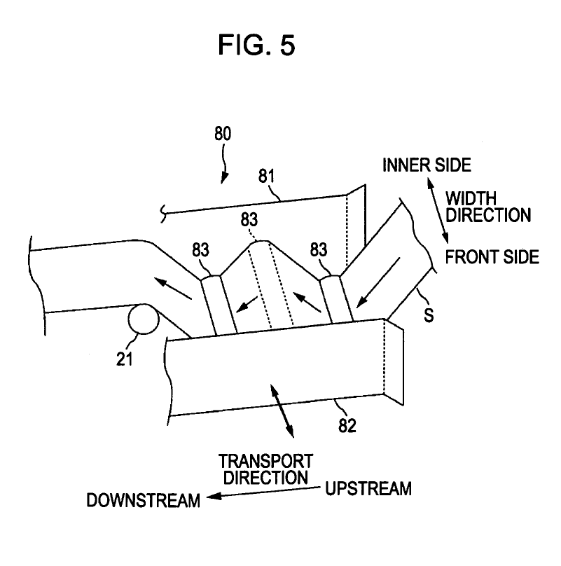

FIG. 5 is a diagram showing a width guiding part 80. The width guiding part 80, as shown in FIG. 2, is located on the upstream side of the print area in the transport direction. The width guiding part 80 is configured by a fixed guide rail 81 (corresponding to a fixed guide), a movable guide rail 82 (corresponding to a movable guide), and a transport roller 83. The inner side faces of the fixed guide rail 81 and the movable guide rail 82 are disposed to be parallel to direction X of the X-axis stage 31. By transporting the continuous medium S with both sides of the continuous medium S in the width direction guided by the fixed guide rail 81 and the movable guide rail 82, the continuous medium S is supplied to the print area in a state that the continued direction of the continuous medium S and the transport direction (direction X) of the printer 1 are parallel to each other. In this embodiment, the fixed guide rail 81 and the movable guide rail 82 extend to the print area, and the continuous medium S in the print area is transported with guided by the guide rail. However, the present invention is not limited thereto. Thus, only on the upstream side of the print area, the continuous medium S is transported with the side face of the continuous medium S guided by the guide rail.

In addition, the fixed guide rail 81 is located on the inner side in the width direction, and the fixed guide rail 81 is fixed to a base 1′ of the printer 1. On the other hand, the movable guide 82 that is located on the front side in the width direction is configured to be movable in the width direction. Accordingly, a printing operation for a continuous medium S having a different width can be performed. In addition, a side face of the continuous medium S on one side (the inner side) has a fixed position in the printer 1 on the width direction (direction Y) all the time, and a side face of the continuous medium S on the other side (the front side) in the width direction has a variable position in the printer 1 which changes in accordance with the width of continuous medium S.

Then, as an operation for preparing a printing process, after the side of the continuous medium S on one side (the inner side) is brought into contact with the fixed guide rail 81, the position of the movable guide rail 82 is adjusted so as to bring the side of the continuous medium S on the other side (the front side) into contact with the movable guide rail 82. The adjustment of the position of the movable guide rail 82 may be performed manually or performed automatically by using a machine.

In addition to the adjustment of the position of the continuous medium S in the width direction, in the width guiding part 80, winding of the continuous medium S1 in the shape of a roll is removed by transporting the continuous medium S in the shape of ripples by using three transport rollers 83.

### Front Surface Printing

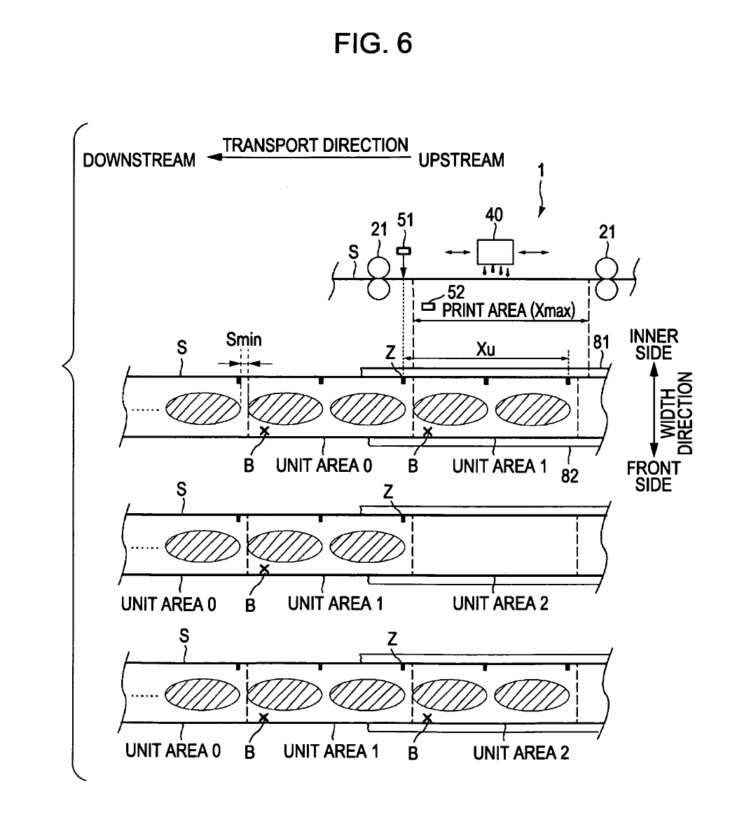

FIG. 6 is a diagram showing a pattern of front surface printing. In the figure, a schematic cross-section diagram of the printer 1 and a diagram of a surface (a surface on a side to be printed first) of the continuous medium S viewed from the top are shown. In FIG. 6, a state that a printing operation is performed for each unit area of the continuous medium S is shown, and a printing operation is sequentially performed from “unit area 0” to “unit area 2”. In addition, on the surface of the continuous medium S, oval images (hatched parts) are configured to be aligned and printed with the minimal gap Smin interposed therebetween in the transport direction. Similarly to the image (FIG. 4) for the unit area described above, by performing one image forming operation, two printing materials (oval images) are printed, and the extraction marks Z are printed together with the printing materials.

The printer 1 alternately performs the image forming operation for each unit area and the transport operation for the continuous medium S. In particular, as shown in FIG. 6, when the printing operation for the “unit area 1” is completed, the continuous medium S is transported in the transport direction by a length Xu of the unit area in the transport direction. Accordingly, “unit area 2” (an area located on the upstream side of “unit area 1”) for which a printing operation has not performed is supplied to the print area, and a printing operation for “unit area 2” is performed.

In order to transport the continuous medium S by a predetermined amount (the length Xu of the unit area in the transport direction) in accordance with one transport operation, the transport unit 20 transports the continuous medium S with reference to the extraction mark Z. As shown in FIG. 6, a transport sensor 51 used for detecting the extraction mark Z is disposed in a position of the print area departed from an extraction mark Z, which is located on the upstream side of “unit area 1”, by the length Xu to the downstream side in the transport direction. In such a case, when the transport unit 20 transports the continuous medium S until an extraction mark (a second extraction mark Z) on the downstream side of “unit area 1” is detected by the transport sensor 51, the continuous medium S can be transported to the downstream side by a predetermined amount Xu.

In addition, in order to detect the extraction mark Z that is printed on the surface of the continuous medium S in a surface printing operation, the transport sensor 51 is located on the upper side of the continuous medium S. The transport sensor 51 emits light from the upper side of the continuous medium S and detects the extraction mark Z by using reflected light.

Since the extraction mark Z is printed on the inner side of the continuous medium S in the width direction in the front surface printing process, the transport sensor 51 that detects the extraction mark Z in the front surface printing process is disposed on the inner side of the continuous medium S in the width direction, that is, the fixed guide rail 81 side.

It is assumed that the extraction mark Z is printed on the front side (the movable guide rail 82 side) of the continuous medium S in the width direction. In such a case, the position of the extraction mark Z in the width direction of the printer 1 changes in accordance with the width of the continuous medium S, and accordingly, the transport sensor 51 should be configured to be movable in the width direction. Thus, the position of the transport sensor 51 in the width direction should be determined in accordance with the position of the extraction mark Z in the width direction of the printer 1, and accordingly, it takes a time for preparing a printing operation. In addition, when an error occurs in determining the position of the transport sensor 51 in the width direction, the transport sensor 51 cannot detect the extraction mark Z, and accordingly, the transport unit 20 cannot transport the continuous medium S by the predetermined amount Xu.

Thus, as in this embodiment, in the front surface printing process, the continuous medium S is transported by guiding the inner side (corresponding to the side face on one side) in the width direction, between two sides of the continuous medium S, using the fixed guide rail 81 and guiding the side face (corresponding to the side face on the other side) on the front side using the movable guide rail 82, and the extraction mark Z (corresponding to the transport mark) is printed on the inner side of the continuous medium S, that is, the fixed guide rail 81 side (corresponding to the side face on the one side). Accordingly, the position relationship in the width direction between the transport sensor 51 and the extraction mark Z becomes fixed all the time. As a result, the position of the transport sensor 51 of the printer 1 in the width direction is fixed, and accordingly, the transport sensor 51 can detect the extraction mark Z assuredly.

As described above, the printer 1 can transport the continuous medium S to the downstream side by the length Xu of the unit area in the transport direction. In addition, the printer 1 prints the printing materials continuously such that the oval printing materials are aligned on the surface of the continuous medium S with a same gap (the minimum gap Smin) interposed therebetween in the transport direction by alternately repeating the transport operation for transporting the continuous medium S by the predetermined amount Xu and the image forming operation for the unit area.

When a single-sided printing material is to be produced, only printing materials and the extraction marks Z are needed to be printed on the surface (one side) of the continuous medium S. However, when a double-sided printing material is to be produced, rear face marks B (corresponding to marks) are needed to be printed on the surface of the continuous medium S, in addition to the printing materials and the extraction marks Z. The rear surface mark B(x) is printed in a position, which is located on a side opposite to the position of the extraction mark Z in the width direction, on the surface of the continuous medium S. In other words, the rear surface mark B is printed on the front side of the continuous medium S in the width direction, that is, the movable guide rail 82 side (corresponding to the side face side on the other side) in the front surface printing process. Hereinafter, a method of printing the rear surface by using the rear surface mark B will be described.

### Rear Surface Printing

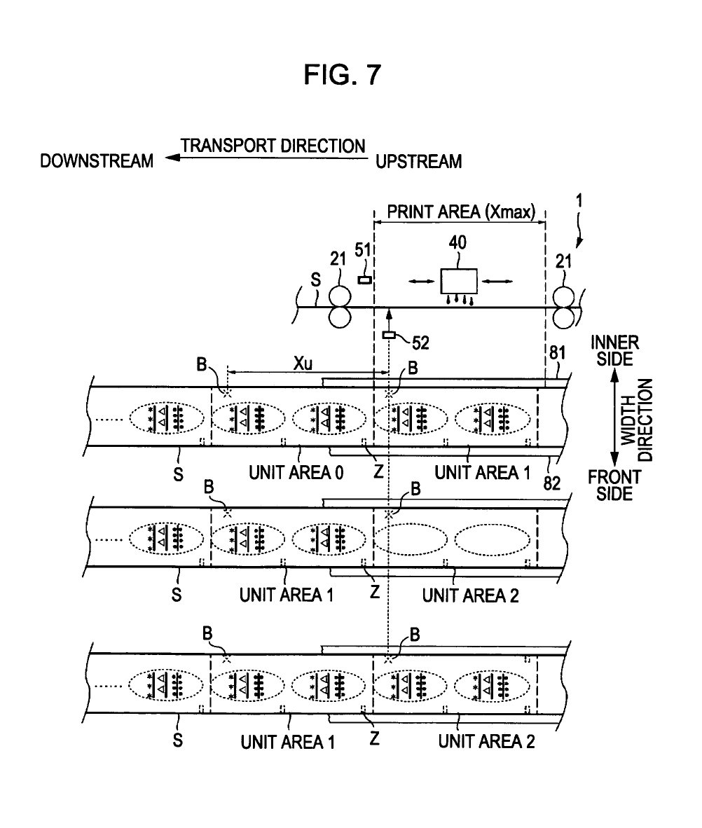

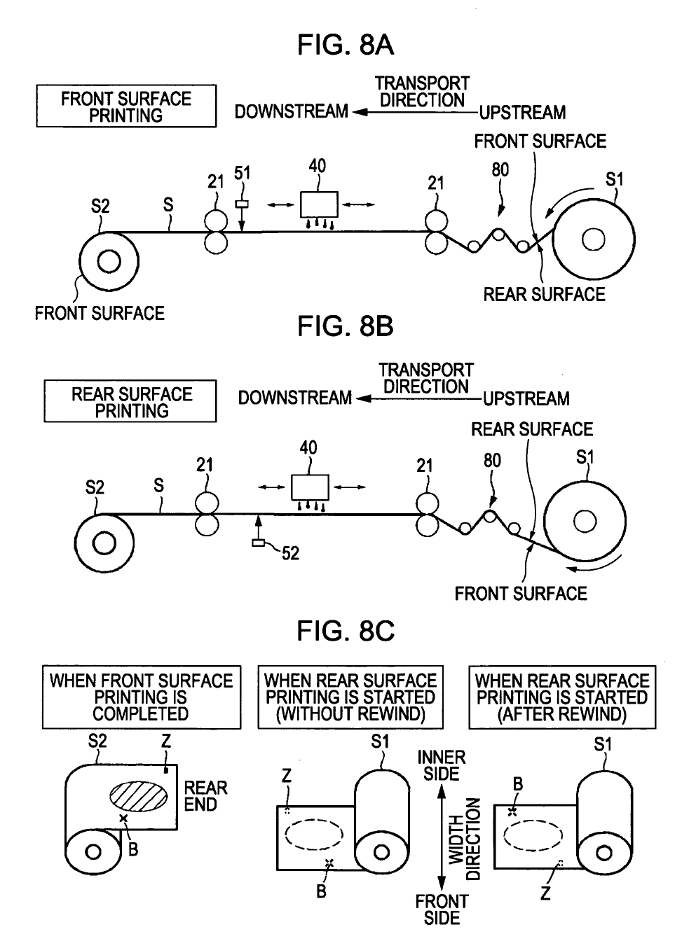

FIG. 7 shows a pattern of rear surface printing. FIGS. 8A and 8B are diagrams showing a difference in supply of the continuous medium S in the front surface printing process and the rear surface printing process. FIG. 8C is a diagram showing the positions of the rear surface marks B at the end of the front surface printing process and the start of the rear surface printing process. For the rear surface printing process, the continuous medium S2 for which the surface printing process has been completed is supplied again to the print area from the upstream side in the transport direction of the printer 1. In the surface printing process, as shown in FIG. 8A, an image is printed on the outer surface of the roll-shaped continuous medium S1. After completing the surface printing process, the continuous medium S1 is wound such that the printed surface is located on the outer side of the continuous medium S2. Accordingly, when the continuous medium S2, for which the surface printing process has been completed, is supplied in the same manner as in the surface printing process in the rear surface printing process (S1 shown in FIG. 8A), the printed surface of the continuous medium S faces the head unit 40.

In addition, when the continuous medium S is not rewound, as shown in FIG. 8C, a rear end part (a print ending area) of the continuous medium S2 at the end of the front surface printing process is printed first in the rear surface printing process. In such a case, the rear surface mark B is located on the front side in the width direction, that is, the movable guide rail 82 side. When the rear surface mark B is located on the movable guide rail 82 side, the position of a rear surface sensor 52 should be changed in accordance with the width of the continuous medium S, and accordingly, a time for preparing the printing process is required. In addition, when an error occurs in determining the position of the sensor, the rear surface mark B cannot be detected. Thus, the front end part (a print starting area) in the front surface printing process is configured to be the print stating area in the rear surface printing process, so that the rear surface mark B is located on the inner side in the width direction, that is, the fixed guide rail 81 side in the rear surface printing process. Accordingly, the continuous medium S2 for which the front surface printing process has been completed is needed to be rewound.

In such a case, when the printed face (surface) is rewound to be positioned on the outer side, as shown in FIG. 8B, the continuous medium S is supplied in a direction (the clockwise direction) opposite to the direction used in the front surface printing process in the rear surface printing process. Accordingly, a surface opposite to the printed surface faces the head unit 40. On the other hand, when the printed face (surface) is rewound to be positioned on the inner side, as shown in FIG. 8A, the continuous medium S1 can be supplied.

In addition, as an operation for preparing the rear surface printing process, similar to that in the front surface printing process, the side face of the continuous medium S on the inner side in the width direction is brought into contract with the fixed guide rail 81, and then, the position of the movable guide rail 82 is adjusted such that the side face of the continuous medium S on the front side in the width direction is brought into contact with the movable guide rail 82.

In FIG. 7, a schematic cross-section view of the printer 1 and a diagram of the rear surface (a surface to be printed second) of the continuous medium S viewed from the top are shown. In addition, outlines of printing materials (oval images) and marks (the extraction mark Z and the rear surface mark B) which are printed on the surface of the continuous medium S are virtually denoted by dotted lines in the figure. On the rear surface of the printing material, characters are printed, and the printing materials are finally cut out along the outlines of the oval images printed on the surface. Thus, in the rear surface printing process, the characters are needed to be printed not to protrude from the outlines of the oval images printed in the front surface printing process.

In this embodiment, the rear surface printing process for the continuous medium S is performed in prediction of the position of the surface image for each unit area (one image forming operation). Accordingly, the positional deviation of the front and rear surface images can be prevented. In addition, the size of the unit area for the rear surface printing process is configured to be the same as that for the front surface printing process, and characters for two printing materials are printed by one image forming operation in the rear surface printing process.

In particular, as shown in FIG. 7, when the rear surface printing process for “unit area 1” is completed, the continuous medium S is transported to the downstream side until the rear surface sensor 52 detects the rear surface mark B printed on the next area of “unit area 2”. Then, the position of the unit area to be printed next in the transport direction is determined.

In addition, in the rear surface printing process, all the rear surface marks B are printed on the front surface side. Thus, in the front surface printing process, the transport sensor 51 detects the extraction mark Z printed in the previous unit area for transporting the continuous medium S. On the other hand, in the rear surface printing process, the rear surface sensor 52 detects the rear surface mark B printed in the unit area (the front surface side) to be printed for transporting the continuous medium S. Accordingly, the rear surface sensor 52 is positioned within the print area.

For example, as shown in FIG. 7, the rear surface sensor 52 is disposed in a position that is departed from the front end on the downstream side in the transport direction of the print area toward the upstream side by a predetermined distance. Thus, in the front surface printing process, the rear surface mark B is printed in the position that is departed from the front end of the unit area on the downstream side toward the upstream side by the predetermined distance. Accordingly, when the rear surface sensor 52 detects the rear surface mark B in the rear surface printing process, the front end of the print area on the downstream side and the front end of the unit area on the downstream side in the front surface printing process coincide with each other. In the front surface printing process (FIG. 6), the printing material is printed in a state that the front end of the unit area on the downstream side and the front end of the printing material (the oval image) on the downstream side coincide with each other. Accordingly, for printing an image in the unit area in the rear surface printing process, the characters are printed within the oval image in consideration of coincidence on the surface side (the lower face side) of the unit area between the front end of the unit area on the downstream side and the front end of the printing material (the oval image) on the downstream side (the print data for the unit area is generated). Accordingly, the characters are printed on the rear surface to be placed within the oval image printed on the front surface without a positional deviation of the front and rear surface images.

In addition, a gap in the transport direction between the rear surface mark B of the unit area (“unit area 0”) printed first and the rear surface mark B of the unit area (“unit area 1”) printed next is the length Xu of the unit area in the transport direction. Accordingly, when the continuous medium S is transported to the downstream side until the rear surface sensor 52 detects the next rear surface mark B, the continuous medium S is transported by a same amount (the predetermined amount Xu) as that in the front surface printing process by performing one transport operation. The printer 1 alternately repeats the transport operation for transporting the continuous medium S to the downstream side in the transport direction by the predetermined amount Xu (the length of the unit area in the transport direction) by performing one transport direction and the image forming operation for printing characters for two printing materials, and thereby performing rear surface printing for the printing materials.

As described above, in the rear surface printing process, the continuous medium S is transported by guiding the side face (corresponding to the side face on the other side) on the inner side in the width direction, between two side faces of the continuous medium S, using the fixed guide rail 81 and guiding the side face (corresponding to the side face on one side) on the front side using the movable guide rail 82. Then, a printing process is performed by determining the position of the continuous medium S in the transport direction based on the detection position in which the rear surface mark B has been detected by the rear surface sensor 52 for each unit area. Accordingly, the positional deviation of the front and rear surface images can be prevented. In addition, in the rear surface printing process, the rear surface marks B that are printed on the front surface of the continuous medium S face the lower side. Thus, the rear surface sensor 52 that is used for detecting the rear face mark B is located on the lower side of the continuous medium S. The rear surface sensor 52 emits light from the lower side of the continuous medium S and detects the rear surface mark B by using reflected light.

In addition, in this embodiment, the rear surface mark B is printed on the front side (the movable guide rail 82 side) in the width direction of the continuous medium S in the front surface printing process. Thus, in the rear surface printing process, the rear surface mark B is located on the inner side in the width direction of the continuous medium S, that is, on the fixed guide rail 81 side. Accordingly, the rear surface sensor 52 that detects the rear surface mark B in the rear surface printing process, similarly to the transport sensor 51, is disposed on the inner side in the width direction of the continuous medium S, that is, the fixed guide rail 81 side.

As described above, when the rear surface mark B detects the rear surface sensor 52, the rear surface mark B is located on the fixed guide rail 81 side. Thus, the position relationship in the width direction between the rear surface sensor 52 and the rear surface mark B can be maintained to be fixed all the time. As a result, the position of the rear surface sensor 52 of the printer 1 in the width direction is fixed, and the rear surface sensor 52 can detect the rear surface mark B assuredly.

In addition, it can be paraphrased that by not locating the rear surface sensor 52 on the movable guide rail 82 side, the position of the rear surface sensor 52 in the width direction is not needed to be determined in accordance with the length of the continuous medium S in the width direction and a time required for the entire printing process can be shortened. In addition, since the position of the rear surface sensor 52 in the width direction is not needed to be determined, a possibility that that rear surface sensor 52 cannot detect the rear surface mark B due to an error generated in determining the position is removed.

In this embodiment, the positions of the transport sensor 51 and the rear surface sensor 52 in the transport direction are different from each other (FIGS. 6 and 7). As described above, while the transport sensor 51 detects the extraction mark Z that is printed in the previous unit area, the rear surface sensor 52 detects the rear surface mark B that is printed in the unit area to be printed. In order to perform the above-described operation, the transport sensor 51 is located on the downstream side of the print area, and the rear surface sensor 52 is located within the print area.

However, it may be configured that the rear surface sensor 52 is disposed on the downstream side of the print area and the continuous medium S is transported based on the result of detection of the rear surface mark B that is printed on the previous unit area. In addition, the rear surface sensor 52 may be disposed on the upstream side of the print area. However, when the continuous medium S is transported based on the rear surface mark B of the unit area to be printed, the front end of the print area on the downstream side and the front end of the front-side unit area on the downstream side can coincide with each other assuredly in the rear surface printing process. Accordingly, the positional deviation between the front and rear surface images can be decreased further. When a minute error is generated in the transport operation for the front surface printing process, the gap between the rear surface mark B printed in the previous unit area and the rear surface mark B printed in the next unit area is not the length Xu of the unit area in the transport direction but a length including the transport error. In other words, by determining the position of the unit area in the transport direction in accordance with the rear surface mark B of the unit area to be printed, the characters can be assuredly printed (the rear surface printing) in accordance with the printing material (the oval image) printed on the front surface.

In addition, by having the positions of the transport sensor 51 and the rear surface sensor 52 in the transport direction to be different from each other, placement of the continuous medium S can be detected assuredly. The transport sensor 51 and the rear surface sensor 52 detect the placement of the medium based on whether the reflectivity for the light emitted from the sensor is different from that of the medium. In order to detect the medium as described above, it is preferable that the surface facing the sensor is formed of an object (for example, a part painted in black) having reflectivity different from that of the medium. Thus, as in this embodiment, by having the positions of the transport sensor 51 that is located on the upper side of the continuous medium S and the rear surface sensor 52 that is located on the lower side of the continuous medium S to be deviated from each other, it can be avoided that the transport sensor 51 faces the rear surface sensor 52. As a result, the degree of freedom for selecting an object that forms the surface facing the sensor is improved, and thus, an object having not the reflectivity of the medium from which the placement of the medium can be detected assuredly can be used. In particular, when the continuous medium is transparent (a transparent film or the like), by arranging a reflective plate on the surface facing the sensor, existence of a mark (the extraction mark Z and the rear surface mark B) can be detected with high precision. In addition, by having the positions of the transport sensor 51 and the rear surface sensor 52 in the transport direction to be deviated from each other, attachment of the sensor can be easily performed in a case where the rear surface sensor 52 is attached on the back, and accordingly, generation of an installation error can be prevented. Therefore, as an option for a printer used for single sided printing, the rear surface printing can be performed.

### Other Embodiments

In the above-described embodiments, although a printing system having an ink jet printer has been mainly described, disclosure of a double-sided printing method and the like are included therein. In addition, the above-described embodiments are not for purposes of limiting the invention but for easy understanding of the invention. It is apparent that the invention may be changed or modified without departing from the gist of the invention and equivalents thereof belong to the invention. In particular, embodiments described below belong to the invention.

### Printing Device

In the above-described embodiments, the print data generating PC generates the print data such that the extraction mark Z is printed on the inner side in the width direction in the front surface printing process and the rear surface mark B is printed on the front side. Thus, the printing system in which the ink jet printer and the print data generating PC are interconnected corresponds to a printing device. However, the printing device is not limited thereto. When the printer 1 is responsible for the role of generating the print data, the printer as a single body corresponds to the printing device.

In the above-described embodiments, the ink jet printer has been described as an example of the printing device. As a method of ejecting ink from a nozzle, a piezo type in which ink is ejected by applying a voltage to a driving element (piezo element) so as to expand or shrink a ink chamber or a thermal type in which air bubbles are generated in a nozzle by using a heating element and ink is ejected by using the air bubbles may be used. In addition, the printing device is not limited to the ink jet printer. Thus, a printing device such as a heat transfer printer or a dot impact printer may be used.

In the above-described embodiments, although the printing system using the printer 1 that alternately performs the image forming operation and the transport operation has been described, however, the printing system is not limited thereto. For example, a printer (so-called a line printer) in which nozzles located on the lower face of a head are aligned over the width of the continuous medium in the width direction may be used.

### Printing Material

In the above-described embodiments, a printing material that is attached to a product has been described as an example, however, the printing material is not limited thereto. For example, for a printing material (a small product such as a cellular phone strap or a key holder) in which images area printed on both sides, the positional deviation of front and rear surface images can be prevented by using the above-described printing method.

What is claimed is:

1. A printing method using a printing device having a transport mechanism that transports a continuous medium in a transport direction, a head that prints an image on the continuous medium, and a sensor, the printing method comprising:
transporting the continuous medium with one side face of two side faces of the continuous medium guided and printing a mark on the other side face of the continuous medium at a time when an image is printed on a front surface of the continuous medium; and
transporting the continuous medium with the other side face of the continuous medium guided and printing an image based on a detection position acquired from detecting the mark by using the sensor at a time when an image is printed on a rear surface of the continuous medium.

2. The method according to claim 1,
wherein the printing device includes a fixed guide and a movable guide,
wherein the movable guide can be moved in a width direction that is a direction for intersecting the transport direction,
wherein the continuous medium is transported with the one side face of the continuous medium guided by the fixed guide and the other side face of the continuous medium guided by the movable guide at the time when the image is printed on the front surface of the continuous medium, and
wherein the continuous medium is transported with the one side face of the continuous medium guided by the movable guide and the other side face of the continuous medium guided by the fixed guide at the time when the image is printed on the rear surface of the continuous medium.

3. The method according to claim 1,
wherein when the image is printed on the front surface of the continuous medium, a transport mark that is different from the mark is printed on the one side face of the continuous medium, and
wherein the transport mechanism transports the continuous medium based on a detection position acquired from detecting the transport mark by using a transport sensor that is different from the sensor.

4. The method according to claim 3,
wherein the sensor and the transport sensor are disposed to be deviated from each other in the transport direction.

5. A printing device comprising:
a transport mechanism that transports a continuous medium in a transport direction;
a head that prints an image on the continuous medium; and
a sensor,
wherein the continuous medium is transported with one side face of two side faces of the continuous medium guided and a mark is printed on the other side face of the continuous medium at a time when an image is printed on a front surface of the continuous medium, and
wherein the continuous medium is transported with the other side face of the continuous medium guided, and an image is printed based on a detection position acquired from detecting the mark by using the sensor at a time when an image is printed on a rear surface of the continuous medium.

6. A method of producing a printing material in which images are printed on front and rear surfaces of a continuous medium by using a printing device having a transport mechanism that transports a continuous medium in a transport direction, a head that prints an image on the continuous medium, and a sensor, the method comprising:
transporting the continuous medium with one side face of two side faces of the continuous medium guided and printing a mark on the other side face of the continuous medium at a time when an image is printed on a front surface of the continuous medium, and
transporting the continuous medium with the other side face of the continuous medium guided and printing an image based on a detection position acquired from detecting the mark by using the sensor at a time when an image is printed on a rear surface of the continuous medium.
